(19) United States
(12) Patent Application Publication
(10) Pub. No.: US 2008/0021968 A1
(43) Pub. Date: Jan. 24, 2008

(54) Low bandwidth chat system

(76) Inventors: Kenneth D. Majors, Lake Oswego, OR (US); Scott Deboy, Hillsboro, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/880,132

(22) Filed: Jul. 19, 2007

Related U.S. Application Data
(60) Provisional application No. 60/832,211, filed on Jul. 19, 2006.

(51) Int. Cl. G06F 15/173

(52) U.S. Cl. 709/206

(57) ABSTRACT

A chat system provided in a computer network including a plurality of client workstations and a server computer.

### CROSS REFERENCE TO RELATED APPLICATIONS

This application claims the benefit of U.S. Provisional App. No. 60/832,211, filed Jul. 19, 2006.

### BACKGROUND OF THE INVENTION

The present invention relates to a chat system provided in a computer network including a plurality of client workstations and a server computer.

With increasing computer performance and the adoption of computer networks, such as the Internet, joint communications over the computer network has become widespread. Chat systems using the computer network have become prevalent, such as Yahoo IM and MSN Messenger. The chat systems permit text messaging, sharing of pictures, audio communication, and video communication between a plurality of users. The chat systems are more interactive for effective two-way communication in comparison to electronic mail.

In conventional chat systems, a client workstation is connected to a predetermined channel of the system facilitated by a server computer. During a chat session between a plurality of client workstations connected to the server computer, the user is able to view the contents of a chat session in real time. In addition, a log file containing the contents of a chat session is stored on client workstation so that the user can later view or share the contents of the stored file.

### BRIEF DESCRIPTION OF THE SEVERAL VIEWS OF THE DRAWINGS

FIG. 1 is a diagram of a computer network to which a communication management system.

FIG. 2 illustrates a website with a chat interface.

FIG. 3 illustrates a client-server and peer-to-peer chat network.

### DETAILED DESCRIPTION OF PREFERRED EMBODIMENT

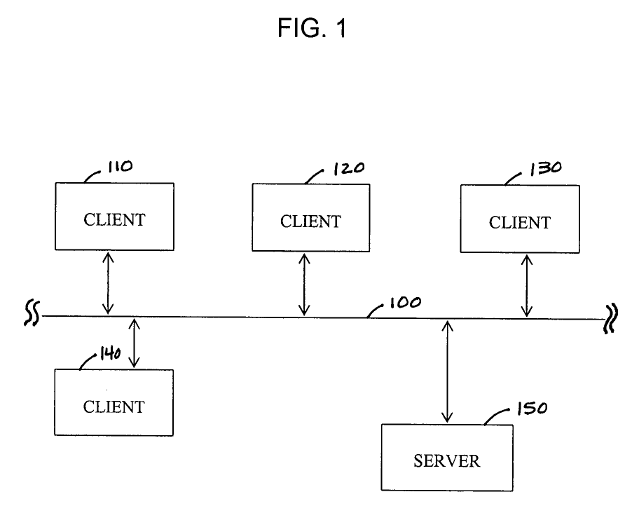

FIG. 1 shows a computer network with a chat system. As shown in FIG. 1, the computer network 100, such as a local area network (LAN), wide area network, wireless network, or the Internet, includes a plurality of client workstations 110, 120, 130, 140, and a server computer 150 which are connected together by the network 100. The computer network of FIG. 1 is illustrated to give a typical example of the configuration of the computer network. A chat system is provided by, for example, a server 150 of FIG. 1. The server 150 enables a user of the client workstation linked to the computer network to carry out a chat among the users of the other client workstations. The system may include a client server arrangement, and/or peer-to-peer arrangement.

The chat system may provide a plurality of channels. For example, a user of the client workstation 110, which is connected to a certain channel of the chat system, can view on a monitor of the workstation 110 the contents of the chat among the client workstations which are connected to the same channel of the chat system. During the chat session, the user of the client workstation 110 types in text to share with others, using an input device of the client workstation 110, and the text input by the user is transmitted through the computer network to all the client workstations connected to the same channel of the chat system. Each user may be connected to multiple simultaneous chat sessions.

The chat system may save log files of the content presented of particular channels of the chat system on the client workstations and/or the server computer.

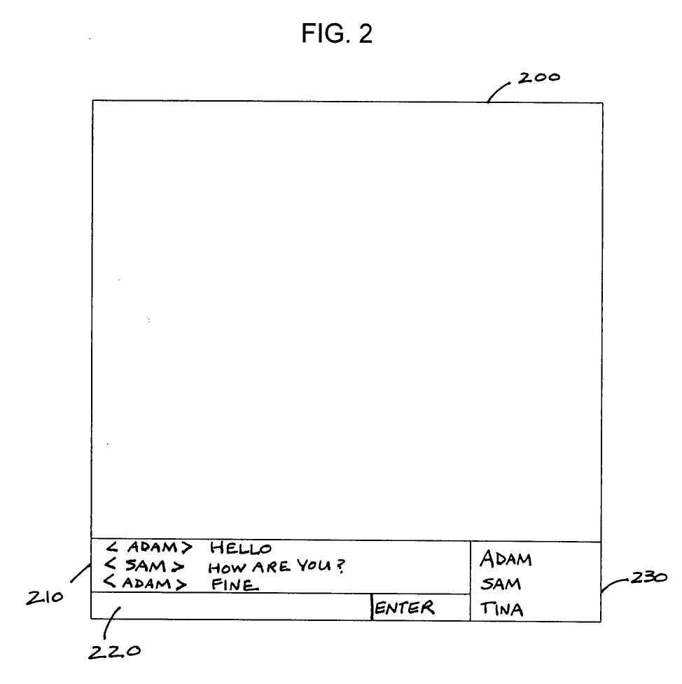

FIG. 2 illustrates a website 200 presented on a user's computer that may show any desirable content, typically in a browser. A plug-in to the browser 200 may be provided to link together, through the server 150, different users who are currently viewing the website 200. A chat window 210 may display recent messages provided to all the viewers of the website 200 that are also interconnected to the server 150. A window 220 may be provided for the user to input a text message to share with all the other users. A window 230 may display the users that are currently viewing the website as provided by the server 150. When the user inputs a message it is posted at the server 150 for the other users to subsequently obtain. Likewise, as the user changes to different websites the currently viewed website location is provided to the server 150. Message are stored by the server 150 in a database where the message is associated with the website (e.g., URL of the website). In order to update the messages 210 and viewers 230 the client's computer periodically queries the server 150 to obtain additional message information for the currently viewed website. In this manner, different users may discuss a currently viewed website. Unfortunately, for a large number of users the periodic queries to the server 150 may tend to overwhelm the capabilities of the server 150.

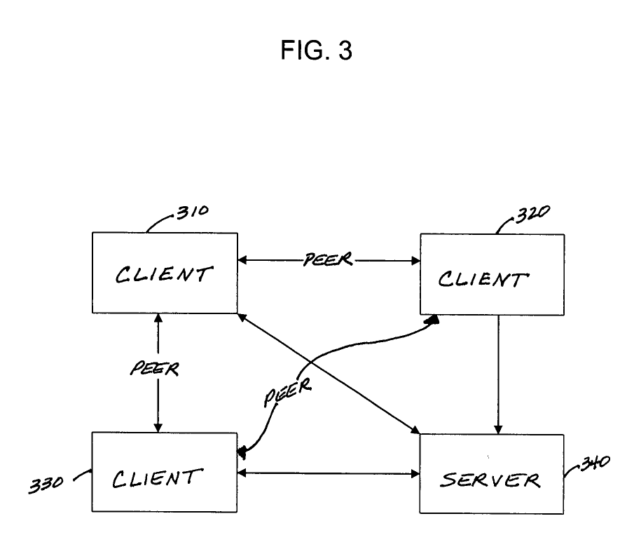

Referring to FIG. 3, a modified technique for configuring a chat conference involves client computers 310, 320, 330 authenticating by communication with the server 340. The clients 310, 320, 330 may log into the chat system on the server 340 using their user name and password. In this manner, the user may have a persistent user name among different chat sessions and a persistent user name shown to other users. The server 340 may provide the clients with a list of current viewers for a particular website 200. In addition, the server 340 may provide the messages for each particular website 200 to the appropriate viewers using push technology rather than a query technology.

The use of a website for the identification is an appropriate technique for the joining of viewers together because each website is unique and is generally of a similar interest, such as snowboarding. The viewers may be grouped by the main domain (www.amazon.com) or by a sub-domain such as (www.amazon.com/snowboards/) or both. In addition, the server 340 may permit the users to enter a text identifier for the name of the chat room rather than using a URL.

To sign into the chat functionality, preferably the users authenticate with the server 340. If desired, the system may permit the users to use an anonymous login name, or a stateful name that is persistent between logins and identified with a particular user. The chat location may be associated with a currently viewed website or otherwise identified by a textual identifier. Since the server 340 is used for logins and website identification, a set of chat room preferences for a particular viewer may be stored on the server 340. The user may add to the stored chat preferences, re-order the chat preferences, and delete stored chat preferences.

In many cases the client communication with the server 340 may be generally in a client-server manner. In this manner, all of the messages are posted to the server 340 and obtained from the server 340 by other clients in a particular chat session, preferably using a push technology. This permits data to be sent as needed rather than responding to lots of queries when there is no data to be provided. In order to reduce the bandwidth requirements for the server 340, to reduce bandwidth requirements between one or more clients on a particular local network and a server 340 outside of the local network, such as on the Internet, the system permits chat communications to be based upon a peer-to-peer technique.

In many cases the chat system may permit text, audio, and video communication. Different types of communication tend to require different amounts of bandwidth, with video being the most bandwidth intensive. The server 340 may direct the clients to communicate in a peer-to-peer manner to reduce the bandwidth requirements for the server 340 for some or all of the data transmissions. In addition, the peer-to-peer communication may be text, audio, and/or video. The addresses (way to communicate with) of other clients may be obtained by the clients by any mechanism, such as for example, a list of client machines posted in an accessible location, an internal list of client machines, or a discovery mechanism.

The preferred peer-to-peer network mechanism uses JXTA which includes a peer-to-peer frame and a network abstraction framework. In many systems, a firewall makes it difficult to connect between different machines because of the limitations in communication. To assist in the communication, a relay operating on a computer accessible over the Internet may be used. The relay may include, for example, HTTP communications or TCP socket communications. The relay normally includes an accessible port to which a client may communicate with in a two way communication. The relay, in turn, provides the communications to the desired destination. In this manner, the user can access other users while being protected behind a firewall.

A software based “rendezvous” program provides a network abstraction and permits a user to provide information about themselves. The information includes how to locate the user. For example, a request is passed to the rendezvous to send information to a particular user, which is passed to appropriate relays to the desired user. Typically a user's private IP address is not published by the rendezvous to other users.

The network configuration may include a distributed hash table, such as a plurality of rendezvous devices linked together with one or more relays. The hash table may be a loosely consistent distributed hast table (DHT).

The access to the chat functionality may be provided by a toolbar functionality in the browser.

The chat functionality provided within the browser may further report to the user, such as in a window alongside the website, a list of the users who are visiting the particular website and/or sub-website. In this manner, the user does not necessarily need to join the particular chat for a website, but nevertheless, is aware of the users that are currently in a particular chat. This permits the user to avoid attempting to chat for website with a limited number of users, or otherwise to many users, or otherwise without the desired users. Hence, the user has the option to selectively not enter a chat for a particular website, while still being able to see who is currently in such chat session.

The user's name may be consistent among all the websites so that the user may have a consistent profile or may be different for particular websites. In addition, by the user having an identity for a particular website they may develop a reputation for providing good information. For example, by visiting often, by providing comments, etc., the user may build karma. As the user builds karma this indication of increased karma may be visible to the other users. A user may likewise grant additional karma to other users, typically for providing good information. In this manner, the system builds some trust.

In the typical chat configuration the user will tend to subscribe to a plurality of different channels, rooms, etc. For each user, a virtual connection generally referred to as a socket, is created between the user and the server. Over the socket, the user may send messages to each channel, etc. However, when the user subscribes to a large number of channels, etc., such as 100 such subscriptions, then each message which is of a general broadcast will be forwarded to all of the subscriptions. For example, a user that joins 500 different channels upon signing into the server may send the same message (e.g., “Hello”) 500 times to the server for broadcasting to other users in each channel sequentially.

To reduce the potential overloading of the server with excessive un-necessary data traffic, the user preferably subscribes to the server. Upon subscription to the server, the user may join the desired channels, or otherwise have a default set of channels to which the user joins. The user may optionally select whether or not to send messages to the rooms to which the user has subscribed. Thus, the general broadcast for a user would need to be only sent once or otherwise less than the number of channels.

The server may, rather than sending a message to all the users in all of the rooms, the server may associate a status of the user. The status may include, for example, available, away, on the phone, invisible, etc. This status may be provided to the other users that are in the selected channels. In this manner, each relevant existing user signed into the server needs to be merely aware of the current status of the user. Moreover, in this manner each new user obtains the status of the user automatically. In this manner, the chat system may include a feature that includes the state of the user provided to other users, rather than needing to broadcast to each room the state of the user which may use excessive bandwidth and resources.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A computer system comprising:
(a) a first user interconnected to a network;
(b) a second user interconnected to said network;
(c) a server interconnected to said network;
(d) said first user joining a first chat session by interconnecting with said server;
(e) said second user joining said first chat session by interconnecting with said server;
(f) said first user sending messages to said second user though said chat session;
(g) where said first chat session is identified by a common website being viewed in a respective browser by said first user and said second user;
(h) wherein said first user and second user communicate in a peer-to-peer manner for transmitting at least some of said messages.

2. The computer system of claim 1 wherein said network is an Internet.

3. The computer system of claim 1 wherein said first user and said second user are interconnected to a second chat session with said server.

4. The computer system of claim 1 wherein said chat session is through a plug in for said browser of said first user.

5. The computer system of claim 4 wherein said plug in presents a message window showing recently displayed messages.

6. The computer system of claim 5 wherein said plug in shows other users in said first chat session.

7. The computer system of claim 6 wherein said plug in provides a window for entering a new message.

8. The computer system of claim 1 wherein said first user and second user communicate in a peer-to-peer manner for video conferencing associated with said chat session.

9. The computer system of claim 1 wherein said first user and second user communicate in a peer-to-peer manner for image sharing associated with said chat session.

10. The computer system of claim 1 wherein said first user and second user obtain messages from said server being provided in a push manner.

11. The computer system of claim 1 wherein said first user and second user communicate in a peer-to-peer manner for audio sharing associated with said chat session.

12. The computer system of claim 1 wherein said first user uses a relay on the network to access said server.

13. The computer system of claim 1 wherein said first user uses a rendezvous feature to access said server.

14. The system of claim 1 wherein said server broadcasts the same information to said first user fewer times than the number of chat sessions said first user has simultaneously active.
